(19) United States
(12) Patent Application Publication
(10) Pub. No.: US 2006/0235656 A1
(43) Pub. Date: Oct. 19, 2006

(54) Product shape designing device

(75) Inventors: Masaaki Mochimaru, Tokyo (JP); Makiko Kouchi, Tokyo (JP)

Correspondence Address: BROWDY AND NEIMARK, P.L.L.C.;624 NINTH STREET, NW, SUITE 300, WASHINGTON, DC, 20001-5303, US

(73) Assignee: National Institute of Advanced Industrial Science Technology, Tokyo (JP)

(21) Appl. No.: 10/554,107

(22) PCT Filed: Apr. 20, 2004
(86) PCT No.: PCT/JP04/05614

§ 371 Date: Oct. 21, 2005

(30) Foreign Application Priority Data
Apr. 21, 2003 (JP) 2003-116181

(51) Int. Cl. G06F 17/50

(52) U.S. Cl. 703/1

(57) ABSTRACT

There is provided a product shape designing device capable of designing a product appropriate for an individual human body shape by considering the designing restrictions of the product and the restrictions when matching the product to a human body. The product shape designing device includes: a measurement unit (101) for measuring a human body shape A, a human body shape B, and a product shape C; a pre-processing unit (102) for performing data conversion for expressing the human body shape A and the human body shape B with the same number of pieces and the same geographical structure coordinates; and a calculation unit (103). According to data on the human body shape A and the human body shape B subjected to the data conversion by the pre-processing unit and the product shape C, the calculation unit (103) calculates a deformation grating G to simultaneously minimize the error between the individuals of the human body shape A and the human body shape B and the error between the circumferential length of the cross section H decided from the product shape C and the design target value of the circumferential length of the cross section, so that the deformation grating G is applied to the product shape C so as to obtain a new product shape F appropriate for the human body shape B.

### BACKGROUND OF THE INVENTION

1. Field of the Invention

The present invention relates to a product shape designing device for industrial products to be fitted on a human body according to his/her body shape, such as clothes, leather articles, glasses, accessories and gas masks, and more particularly to a product shape designing device capable of designing a product that fits an individual's body shape, in consideration of designing limitations imposed by the nature of the product, as well as restrictions imposed so as to make the product appropriately fit the human body.

2. Description of the Related Art

The present inventors have been studying on techniques of designing a product shape that fits a human body utilizing a deformed grid to modify the human body, based on a computer graphic technique called a Free Form Deformation (hereinafter abbreviated as “FFD”) method.

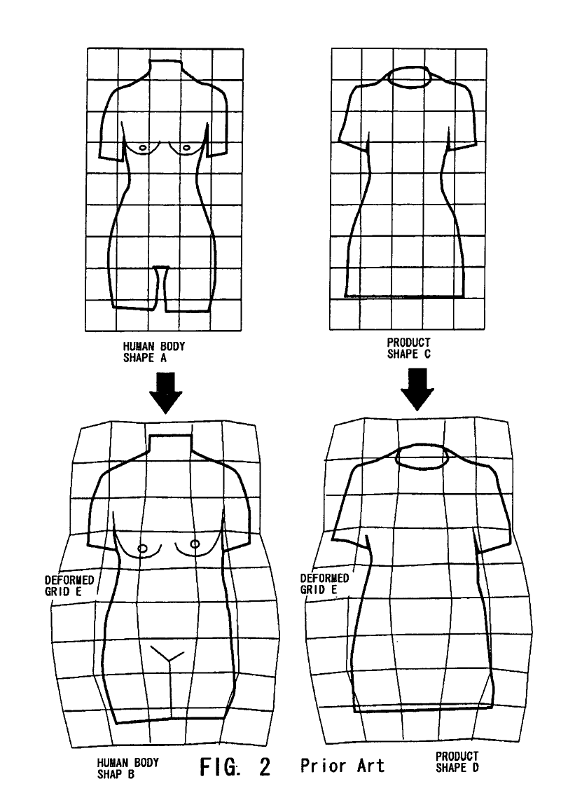

The FFD method is a technique of generating control grid points in a jungle gym configuration around shape data created on a computer, and moving the control grid points so as to smoothly deform the shape data as shown in FIG. 2 (refer to non-patented document 1).

The present inventors have proposed to utilize the FFD method to express variations in body shape among individuals (refer to non-patented document 2). For example, when deforming a human body shape A into another human body shape B, a deformed grid E that can deform the human body shape A into the human body shape B can be calculated, provided that the data of the both human body shapes A and B constitutes a polyhedron described by the same number of vertices of an identical geometric structure (refer to patented documents 1 and 2).

The present inventors have been studying on an apparatus that synthesizes a virtual body shape representing a group based on the deformed grid E (refer to patented document 3), which has led to development of an apparatus for fabricating a dressmaking dummy (refer to patented document 4), as well as a device that provides information on suitable merchandise.

Further, as shown in FIG. 2, applying the calculated deformed grid E to the product shape C, which is designed so as to fit the human body shape A, allows deforming the product shape C into a product shape D, which fits the human body shape B. Accordingly, the present inventors have proposed designing the product shape D on a computer (refer to patented document 5).

Referring to measurement of human body shapes and product shapes, various measuring apparatuses are commercially available or found in publications (refer to non-patented document 3), including those developed by the present inventors.

[Non-patented document 1] SEDERBERG, T. W. 1986, Free-Form deformation of Solid Geometric Models, Proceedings of ACM SIGGRAPH' 86 in Computers & Graphics, 20, 151-160.

[Non-patented document 2] MOCHIMARU, M., KOUCHI, M. and DOHI, M. 2000, Analysis of 3D human foot forms using the FFD method and its application in grading shoe last, Ergonomics, 43, 1301-1313.

[Non-patented document 3] KOUCHI, M. and MOCHIMARU, M. 2001, Development of a low cost foot-scanner for a custom shoe making system, 5th ISB Footwear Biomechanics, 58-59.

[Patented document 1] JP No. 2725739

[Patented document 2] JP No. 3106177

[Patented document 3] JP-A No. 2001-344616

[Patented document 4] JP-A No. 2001-140121

[Patented document 5] JP-A No. 2002-092051

In practice, however, when the deformed grid E, calculated so as to deform the human body shape A into the human body shape B, is applied to the product shape C, the product shape D that fits the human body shape B cannot always be obtained. Even though the product shape D can be calculated at all, the product shape may include many points to be amended, and is hence unpractical from the viewpoint of cost and so on.

More specifically, when calculating the deformed grid E that deforms the human body shape A into the human body shape B and applying such deformed grid E to the product shape C so as to obtain the product shape D as shown in FIG. 2, the circumferential length, for example, of the deformed product shape D may result too short to fit the human body shape B. In addition, the deformation is also applied to particular parts of the product that should remain unchanged (for example parts where a component mass-produced by a mold is employed, such as a front hook of a brassiere or an outer sole of a shoe), which degrades the practical utility of the deformed grid.

### SUMMARY OF THE INVENTION

Accordingly, it is an object of the present invention to provide a product shape designing device capable of designing a product that fits an individual's body shape, in consideration of designing limitations imposed by the nature of the product, as well as restrictions imposed so as to make the product appropriately fit the human body.

The product shape designing device according to the present invention basically comprises a measurement unit that measures a human body shape A, a human body shape B and a product shape C, a data pre-processing unit that converts data so as to express the human body shape A and the human body shape B with the same number of coordinate points on an identical geometric structure, and a calculation unit that calculates, based on the data converted by the data pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applies the deformed grid G thus calculated to the product shape C so as to obtain a new product shape F that fits the human body shape B.

A first aspect of the present invention provides a product shape designing device, capable of designing a product that fits an individual's body shape, comprising a measurement unit that measures a human body shape A, a human body shape B and a product shape C which fits the human body shape A; a pre-processing unit that converts data of the measured shapes into data expressing the human body shape A and the human body shape B with the same number of coordinate points on an identical geometric structure; and a calculation unit that calculates, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applies the deformed grid G thus calculated to the product shape C to thereby deform the product shape C, so as to output data of a new product shape F that fits the human body shape B.

A second aspect of the present invention provides a method of designing a product shape, which allows designing a product that fits an individual's body shape, comprising measuring a human body shape A, a human body shape B and a product shape C which fits the human body shape A; converting data of the measured shapes into data expressing the human body shape A and the human body shape B with the same number of coordinate points on an identical geometric structure; calculating, based on the data converted by the pre-processing unit representing the human body shape A, the human body shape Band the product shape C, a deformed grid G in which a deviation among individuals of the human body shape A and the human body shape B, and a deviation between a circumferential length of a cross-section H determined according to the product shape C and a target circumferential length of the cross-section are minimized at a time; applying the deformed grid G thus calculated to the product shape C to thereby deform the product shape C; and outputting data of a new product shape F that fits the human body shape B.

A third aspect of the present invention provides a computer program for designing a product shape that fits a human body, comprising a first step of converting measurement data of a human body shape A, a human body shape B and a product shape C which fits the human body shape A into data expressing the human body shape A and the human body shape B with the same number of coordinate points on an identical geometric structure; and a second step of calculating, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applying the deformed grid G thus calculated to the product shape C to thereby deform the product shape C, so as to output data of a new product shape F that fits the human body shape B. This program is to be stored in a recording medium for practical use.

In the product shape designing device according to the present invention, the human body shape data obtained by the measurement unit for measuring the human body shape or the product shape is based on measurement at predetermined intervals along the respective axes of a three-dimensional coordinate, for example cross-sectional data in 1 mm pitch, in other words the coordinate point data with the measurement unit placed at the center. Accordingly for example, the data of a tall person includes a larger number of coordinate points than the data of a short person.

Therefore, such data is often inappropriate for comparing individuals. To solve this problem, the product shape designing device according to the present invention converts the data based on, for example, an anatomical landmarks. Alternatively, the product shape designing device according to the present invention performs the pre-processing of converting the coordinate point data obtained by the measurement unit into the same number of coordinate points on an identical geometric structure.

Then the deformed grid is calculated based on the human body shape data converted by the pre-processing unit, i.e. the data expressed by the same number of coordinate points on an identical geometric structure. This leads to the calculation of the deformed grid that reflects the difference in shape between the human body shape A and the human body shape B, based on the human body shape A, the human body shape B and the product shape C which fits the human body shape A, and the deformed grid thus calculated is utilized for designing a new product shape F that fits the human body shape B. During such process, modifications unique to each product are incorporated, to make the product shape designing device more practical. Specifically, the deformed grid G, in which a deviation among individuals of the human body shape A and the human body shape B, and a deviation between a circumferential length of a cross-section H determined according to the product shape C and a target circumferential length of the cross-section are minimized at a time, is calculated, and the deformed grid G thus calculated is utilized for designing the product shape F.

When the product shape data developed based on existing standard human body shape data is available in a form of CAD data, such data may be incorporated so that the measurement unit has only to measure the human body shape B. In this case, the standard human body shape data already established serves as the human body shape A, and data of the product shape that fits the standard human body shape is employed as the product shape C.

The pre-processing unit may be set so as to convert the data of the human body shape and the anatomical landmarks measured by the measuring unit into the data expressing the human body shape with the same number of coordinate points on an identical geometric structure.

The calculation unit may deform the grid, when calculating a deformed grid for deforming a human body shape into another human body shape, under a condition that a circumferential length of a specific cross-section of an existing product shape becomes a predetermined value.

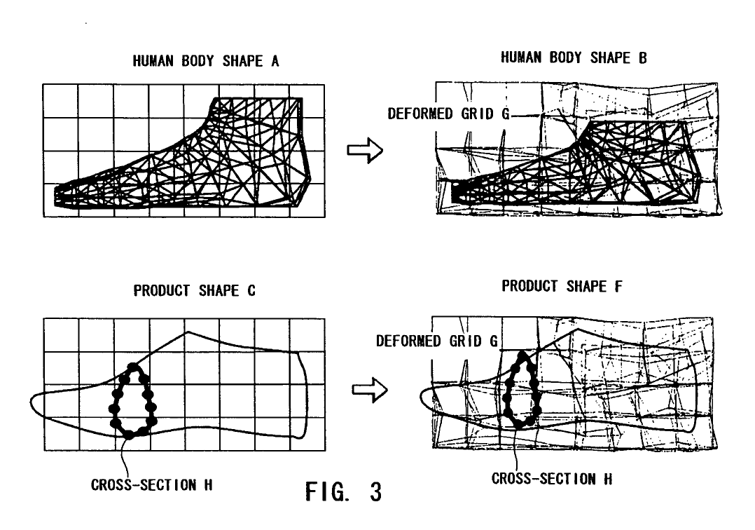

As stated earlier, conventionally the deformed grid E is calculated so as to deform the human body shape A into the human body shape B, and such deformed grid E is applied to the product shape C as shown in FIG. 2, in which case the circumferential length, for example, of the deformed product shape D may result too short to fit the human body shape B. In addition, the deformation is also applied to particular parts of the product that should remain unchanged (for example parts where a component mass-produced by a mold is employed, such as a front hook of a brassiere or an outer sole of a shoe), which degrades the practical utility of the deformed grid. In contrast, the product shape designing device according to the present invention performs an optimization calculation to obtain the deformed grid G, such that not only a deviation between corresponding points in the human body shape A (object to be deformed) and the human body shape B (target of deformation), but also a deviation between a circumferential length of a specific cross-section H in the product shape C to be deformed and a target circumferential length are minimized at a time, for deforming the product shape as shown in FIG. 3. Then the deformed grid G thus calculated is applied to the product shape C, thus to obtain the data of the product shape F.

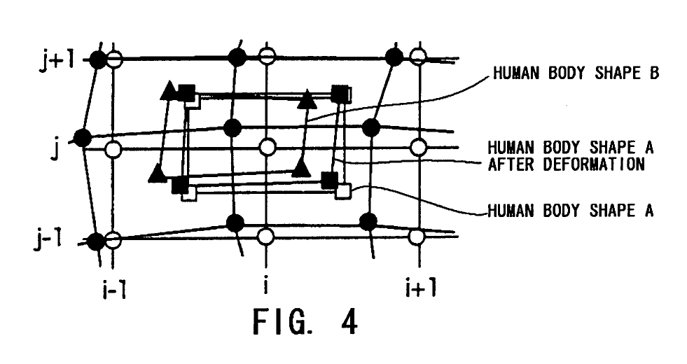

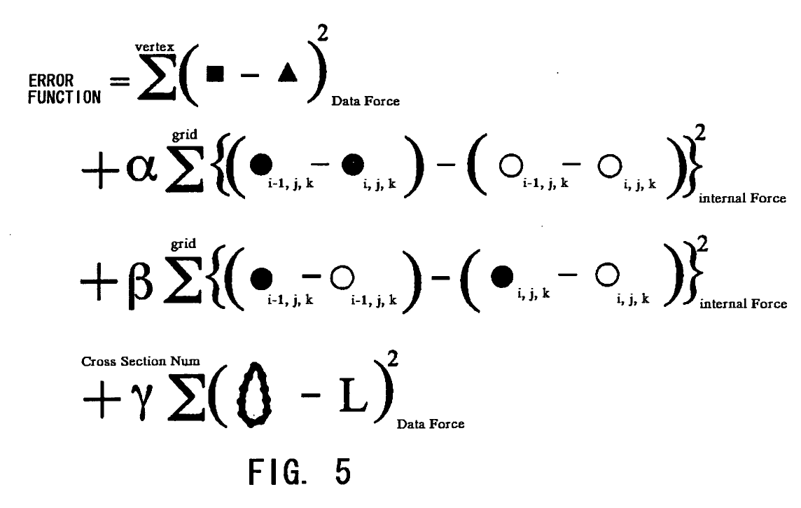

To be more detailed, when calculating the deformed grid G, the optimization calculation of the positions of the control grid points in the deformed grid G is performed such that a weighted summation of aggregated squares of a difference in coordinate between an vertex in the human body shape B deformed by the displacement of the control grid point and a corresponding vertex of the corresponding target deformation shape, with respect to all the vertices, and aggregated squares of a difference between a distance between adjacent grid points and a distance between control grid points prior to deformation, with respect to all the control grid points, becomes a minimal value, as schematically shown in FIGS. 4 and 5.

FIG. 4 schematically depicts the grid points in the deformed grid G, and FIG. 5 graphically describes an error function employed when calculating the deformed grid. Grid points indicated by open squares stand for the data of the human body shape A; grid points indicated by solid squares the data of the human body shape A after deformation; and grid points indicated by solid triangles the data of the human body shape B. Open circles stand for grid points of the deformed grid prior to deformation, while solid circles stand for grid points of the deformed grid after deformation.

In the optimization calculation of the control grid point positions on the deformed grid G, the error function as shown in FIG. 5 is employed. In the error function shown in FIG. 5, the first member represents a deviation determined by the shape data, and the second and the third members are strain energy members for restraining the control grid points from being excessively distorted. The fourth member is an additional deviation member determined by a circumferential length of the product.

The fourth deviation member is defined by a square of the deviation between the circumferential length of the cross-section H, deformed by the displacement of the control grid points extracted in advance from the cross-section H which is important in designing the product shape C, and the target circumferential length. For the calculation of the deformed grid G, the optimization calculation of the control grid point positions on the deformed grid is performed such that the weighted summation of these four members becomes a minimal value. Then the deformed grid G thus calculated is applied to the product shape C, thus to design the product shape F that fits the human body shape B. Such process enables not only deforming the product based on the variation in body shape among individuals, but also designing a product that fits an individual's body shape, in consideration of designing limitations imposed by the nature of the product, as well as restrictions imposed so as to make the product appropriately fit the human body.

As described above, the present invention can solve the problems conventionally observed in the technique of formulating the variation in body shape among individuals in the form of the deformed grid (spatial warp) and applying the variation data to a product shape, the problem that the modified product shape does not fit the human body, as well as the problem that many points in the product shape have to be amended, which degrades the practical utility of the technique from the viewpoint of cost and so on.

### BRIEF DESCRIPTION OF THE INVENTION

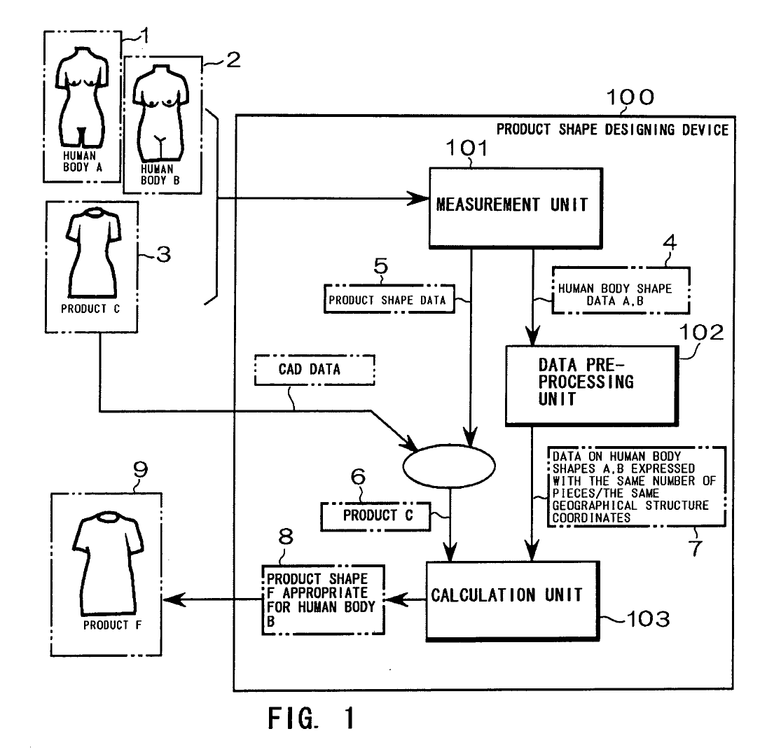

FIG. 1 is a block diagram showing an outline of a system configuration of a product shape designing device according to an embodiment of the present invention;

FIG. 2 includes graphic illustrations for explaining a conventional deformation process based on a deformed grid of prior art;

FIG. 3 includes graphic illustrations for explaining a deformation process based on a deformed grid according to the present invention;

FIG. 4 is a schematic diagram for explaining grid points in the deformed grid;

FIG. 5 is a formula of an error function employed in the calculation of the deformed grid;

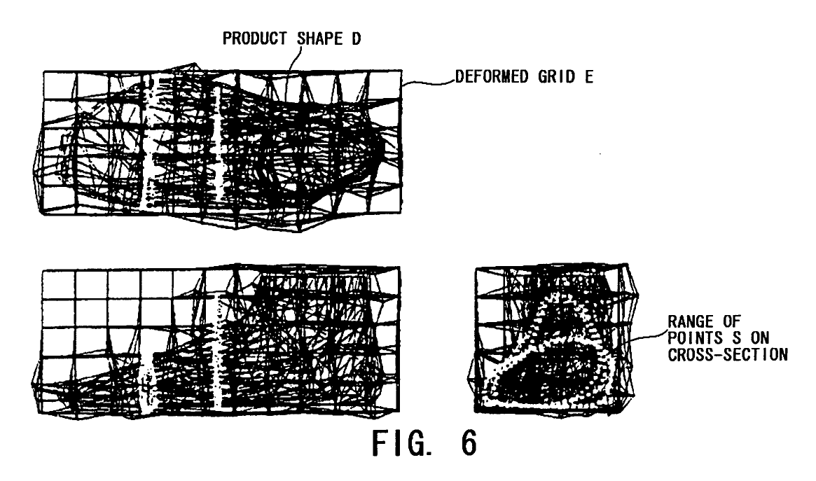

FIG. 6 includes first graphic illustrations for explaining a designing method of a shoe last that fits an individual's foot shape with the product shape designing device according to the present invention;

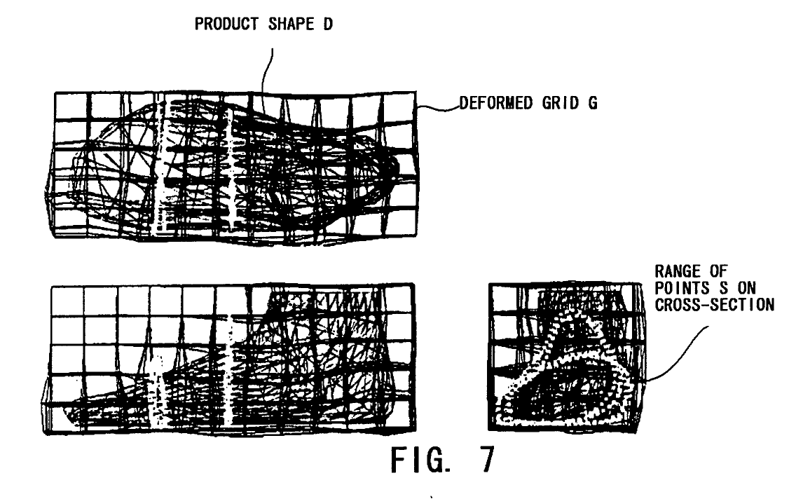

FIG. 7 includes second graphic illustrations for explaining a designing method of a shoe last that fits an individual's foot shape with the product shape designing device according to the present invention; and

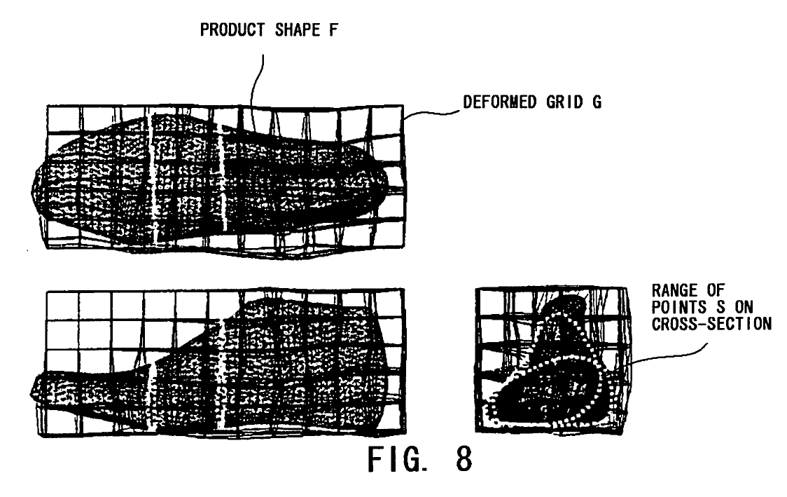

FIG. 8 includes third graphic illustrations for explaining a designing method of a shoe last that fits an individual's foot shape with the product shape designing device according to the present invention.

### DETAILED DESCRIPTION OF THE INVENTION

Referring to the accompanying drawings, an embodiment of the present invention will be described hereunder. FIG. 1 is a block diagram showing an outline of a system configuration of a product shape designing device according to an embodiment of the present invention. In FIG. 1, the numeral 100 designates the product shape designing device, 101 a measurement unit, 102 a data pre-processing unit, and 103 a calculation unit.

The product shape designing device 100 includes the measurement unit 101, the data pre-processing unit 102, and the calculation unit 103. The measurement unit 101 includes a stage on which an object to be measured is placed, an optical scanner and so forth for measuring a three-dimensional shape, and is used for obtaining three-dimensional coordinate data of a human body shape A, a human body shape B, a product shape C and so on. Accordingly, the measurement unit 101 measures the shape 1 of the human body A and the shape 2 of the human body B, and outputs human body shape A/B data 4 in a form of coordinate data. The measurement unit 101 also measures the shape 3 of the product C and outputs product shape data 5 in a form of coordinate data.

The data pre-processing unit 102 and the calculation unit 103 are data-processing devices including a microprocessor (CPU), a memory (RAM) and so on, and programs such as a calculation program and a data conversion program are contained in the memory, for execution of such data processing. The coordinate data representing the human body shape data 4 output by the measurement unit 101 is input to the data pre-processing unit 102, which converts the input data into data expressing the human body shape A and the human body shape B with the same number of coordinate points on an identical geometric structure, thus to generate human body shape A/B data 7. The human body shape A/B data 7 thus generated by the data pre-processing unit 102 is input to the calculation unit 103.

To the calculation unit 103 product shape C data 6 is input, and once the human body shape data 7 is input to the calculation unit 103, the calculation unit 103 calculates, based on the data that has been input, a deformed grid G in which a deviation among individuals of the human body shape A and the human body shape B, and a deviation between a circumferential length of a cross-section H determined according to the product shape C and a target circumferential length of the cross-section are minimized at a time, and applies the deformed grid G thus calculated to the product shape C for deformation of the same, so as to output data 8 of a new product shape F that fits the human body shape B. Then designing data 9 for the product F is generated based on the data 8 which has been output, expressing the product shape F that fits the human body shape B.

Now referring to FIGS. 6 to 8, description will be given on a designing method of a shoe last that fits an individual's foot shape with the product shape designing device according to the present invention. Firstly, an average shape of 41 adult males having the foot size of 253 to 262 mm is employed as the human body shape A, which is the object to be deformed. Then a specific foot shape of one of the 41 subjects is picked up as the human body shape B, i.e. the target of deformation. As the product shape C that fits the human body shape A, a shape of a shoe last C for a sport shoe is employed.

Here, based on the fact that an average foot circumferential length (circumferential length around a portion close to the base of foot fingers) of the 41 subjects is generally the same as the foot circumferential length of the human body shape B, the foot circumferential length of the shoe last shape C (circumferential length of a cross-section of the shoe last corresponding to the cross-section of the foot around which the foot circumferential length is taken) and the foot circumferential length of the shoe last shape F that fits the human body shape B have to accord with each other.

Accordingly, as shown in FIG. 6, a deformed grid E is first calculated in a similar manner to the conventional technique, based on the human body shape A and the human body shape B. The deformed grid E is a grid showing the deformation result from the human body shape A into the human body shape B. The deformed grid E is employed for calculation of displacement of control grid points that deforms human body shape A representing the foot shape into the human body shape B, so as to obtain a product shape D by applying such displacement to the product shape C. Through such process, however, the foot circumferential length of the product shape D results 7.8 mm shorter than the foot circumferential length of the product shape C.

In the case of the shoes being actually sold, the foot circumferential size (such as E, EE, EEE) is varied in an increment of 3 mm for each size grade. Therefore, the product shape D deformed by the conventional technique is too tight for a person who has a foot shape as the human body shape B.

Accordingly, a range of points S is extracted out of the cross-section of the product shape C where the foot circumferential length is to be calculated, and the deformed grid E is modified into a deformed grid G of a shape as shown in FIG. 7, adding a condition that the foot circumferential length defined by the range of points S deformed by the deformed grid E accords with the foot circumferential length of the product shape C before the deformation. The deformed grid G calculated in this way is barely distinguishable from the result of the conventional calculation.

This means that the general feature of the deformed grid adequately reflects the variation among individuals between the human body shape A and the human body shape B. And, as shown in FIG. 8, the new product shape F deformed based on the recalculated deformed grid G has the foot circumferential length that accords with that of the product shape C which is the object to be deformed (the deviation is 0.000 mm), by which it is understood that the foot circumferential length of the product satisfies the target value.

The advantageous features of the product shape designing device according to the embodiment of the present invention can be summarized as follows.

(1) The product shape designing device serves to design a shape of a product so as to fit a human body shape, and includes a measurement unit (101) that measures a human body shape, an anatomical landmarks of the human body and a product shape to generate human body shape data and product shape data, a data pre-processing unit (102) that converts the human body shape data measured by the measurement unit into data expressing the human body shape with the same number of coordinate points on an identical geometric structure, and a calculation unit (103) that converts the shape data with a deformed grid based on FFD method.

(2) The measurement unit, the data pre-processing unit and the calculation unit are respectively provided with a function of storing data in a recording medium and reading out the data from the recording medium, and capable of suspending and resuming the respective data processing jobs. The processed data can be displayed on a display unit. For example, deformed shapes can be displayed as shown in FIGS. 6 to 8. Also, the measurement unit, the data pre-processing unit and the calculation unit are physically or logically connected to one another, for example through a network, for executing the respective jobs.

(3) The data pre-processing unit is provided with a function of reading out the stored human body shape data measured by the measurement unit out of the recording medium physically or logically connected to the data pre-processing unit, expressing the human body shape data with the same number of coordinate points on an identical geometric structure, and storing the human body shape thus expressed in the physically or logically connected recording medium.

(4) The calculation unit receives the input of the data of human body shape A, including the human body shape A stored in the data pre-processing unit and a virtual human body shape A′ generated through a different statistical process from a plurality of human body shapes stored in the data pre-processing unit. Also, the data of human body shape B, including the human body shape B of the individual to whom the product is to be fitted stored in the data pre-processing unit and a virtual human body shape B′ generated through a different statistical process from a plurality of human body shapes representing a group to whom the product is to be fitted, is input to the calculation unit. The data input as the data of product shape C includes the existing product shape C measured by the measurement unit and a product shape C′ additionally designed and electronically expressed. Also, a specific cross-section data H of the product shape C′ is read out from the physically or logically connected recording medium, and input to the calculation unit.

(5) The calculation unit calculates, generates and stores the deformed grid E, which serves to deform the human body shape A or virtual human body shape A′ so as to accord with the human body shape B or virtual human body shape B′ of the individual to whom the product is to be fitted.

(6) The calculation unit also calculates, generates and stores the deformed grid G, which serves to deform the human body shape A or virtual human body shape A′ so as to accord with the human body shape B or virtual human body shape B′ of the individual to whom the product is to be fitted, under a condition that the circumferential length of the specific cross-section H becomes a predetermined value.

(7) In addition, the calculation unit stores the new product shape F generated by deforming the existing product shape C or product shape C′ with the deformed grid G in the physically or logically connected recording medium.

(8) The calculation unit is provided with a display unit for displaying the data at transitions during the respective process. Specifically, the calculation unit can simultaneously display overlapping images of at least three data including the deformed grid E or G, among the human body shape A, virtual human body shape A′, the human body shape B or virtual human body shape B′ of the individual to whom the product is to be fitted, the existing product shape C and product shape C′, the specific cross-section H of the product shape, the deformed grid E or G, and the new product shape F.

As described throughout the foregoing passages, the product shape designing device according to the present invention allows not only deforming a product based on variation in body shape among individuals, but also designing the product that fits an individual's body shape, in consideration of designing limitations imposed by the nature of the product, as well as restrictions imposed so as to make the product appropriately fit the human body. Accordingly, the product shape designing device is quite useful in practical use. The product shape designing device according to the present invention allows upgrading the suitability of the product absorbing the variation among individuals in the product but leaving unchanged the size of the portions where, for example, a component mass-produced by a mold is employed, thus enabling designing a product that fits a specific size and shape in cooperation with the mass-production technique.

What is claimed is:

1. A product shape designing device, comprising:
a measurement unit that measures a human body shape A, a human body shape B and a product shape C which fits the human body shape A;
a pre-processing unit that converts data of the measured shapes into data expressing the human body shape A and the human body shape B with the same number of coordinate points on an identical geometric structure; and
a calculation unit that calculates, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applies the deformed grid G thus calculated to the product shape C to thereby deform the product shape C, so as to output data of a new product shape F that fits the human body shape B.

2. The product shape designing device according to claim 1, wherein the measurement unit only measures the human body shape B; and
the human body shape A includes standard human body shape data, and the product shape C data includes product shape data that fits the standard human body shape.

3. The product shape designing device according to claim 1, wherein the measurement unit measures a human body shape and an anatomical landmarks of a human body; and
the pre-processing unit converts the data of the human body shape and the anatomical landmarks measured by the measuring unit into the data expressing the human body shape with the same number of coordinate points on an identical geometric structure.

4. The product shape designing device according to claim 1, wherein the calculation unit deforms the grid, when calculating a deformed grid for deforming a human body shape into another human body shape, under a condition that a circumferential length of a specific cross-section of an existing product shape becomes a predetermined value.

5. A method of designing a product shape, comprising:
measuring a human body shape A, a human body shape B and a product shape C which fits the human body shape A;
converting data of the measured shapes into data expressing the human body shape A and the human body shape B with the same number of coordinate points on an identical geometric structure;
calculating, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time; applying the deformed grid G thus calculated to the product shape C to thereby deform the product shape C; and outputting data of a new product shape F that fits the human body shape B.

6. A computer program for designing a product shape that fits a human body, comprising:
a first step of converting measurement data of a human body shape A, a human body shape B and a product shape C which fits the human body shape A into data expressing the human body shape A and the human body shape B with the same number of coordinate points on an identical geometric structure; and
a second step of calculating, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applying the deformed grid G thus calculated to the product shape C to thereby deform the product shape C, so as to output data of a new product shape F that fits the human body shape B.

7. A recording medium containing a computer program for designing a product shape that fits a human body, wherein the computer program comprises a first step of converting measurement data of a human body shape A, a human body shape B and a product shape C which fits the human body shape A into data expressing the human body shape A and the human body shape B with the same number of coordinate points on an identical geometric structure; and a second step of calculating, based on the data converted by the pre-processing unit representing the human body shape A, the human body shape B and the product shape C, a deformed grid G in which a deviation among individuals of the human body shape A and the human body shape B, and a deviation between a circumferential length of a cross-section H determined according to the product shape C and a target circumferential length of the cross-section are minimized at a time, and applying the deformed grid G thus calculated to the product shape C to thereby deform the product shape C, so as to output data of a new product shape F that fits the human body shape B.
